(19) United States
(12) Patent Application Publication
(10) Pub. No.: US 2026/0174149 A1
(43) Pub. Date: Jun. 25, 2026

(54) AEROSOL-GENERATING DEVICE INCLUDING AIRFLOW PATH

(71) Applicant: KT&G CORPORATION, Daejeon (KR)

(72) Inventors: Dong Sung KIM, Seoul (KR); Hwikyeong AN, Seoul (KR); Youngbum KWON, Yongin-si (KR); Yong Hwan KIM, Anyang-si (KR)

(73) Assignee: KT&G CORPORATION, Daejeon (KR)

(21) Appl. No.: 19/311,018

(22) Filed: Aug. 27, 2025

(30) Foreign Application Priority Data
Nov. 4, 2024 (KR) 10-2024-0154406

(51) Int. Cl. A24F 40/48; A24F 40/46; A24F 40/51; H05B 6/10

(52) U.S. Cl. CPC A24F 40/48; A24F 40/46; A24F 40/51; H05B 6/108

(57) ABSTRACT

An aerosol-generating device includes a heater module including a sleeve configured to accommodate an aerosol-generating article, and a plurality of pipes configured to guide air from an outside to the sleeve, wherein the plurality of pipes is configured to be mechanically engaged with each other, and at least one of the plurality of pipes is configured to be mechanically engaged with the heater module.

### CROSS-REFERENCE TO RELATED APPLICATION

This application claims the benefit of Korean Patent Application No. 10-2024-0154406 filed on Nov. 4, 2024, in the Korean Intellectual Property Office, the entire disclosure of which is incorporated herein by reference for all purposes.

### BACKGROUND

### 1. Field of the Invention

The disclosure typically relates to an aerosol-generating device, and for example, an aerosol-generating device including an airflow path.

### 2. Description of the Related Art

Techniques for introducing airflows into an aerosol-generating article have been developed to provide atomization performance. For example, aerosol-generating devices that generate an aerosol from an aerosol generating article in a non-burning manner have been developed. The above description is information the inventor(s) acquired during the course of conceiving the present disclosure, or already possessed at the time, and is not necessarily art publicly not known before the present application was filed.

### SUMMARY

An aspect of the disclosure may provide an aerosol-generating device that introduces an airflow into an aerosol generating article.

An aerosol-generating device includes a heater module including a sleeve configured to accommodate an aerosol-generating article, and a plurality of pipes configured to guide air from an outside to the sleeve, wherein the plurality of pipes is configured to be mechanically engaged with each other, and at least one of the plurality of pipes is configured to be mechanically engaged with the heater module.

The plurality of pipes includes a first pipe connected to the sleeve, and the first pipe is configured to guide, in a second direction, air introduced into the first pipe in a first direction in which the first pipe extends, wherein the second direction intersects with the first direction.

The plurality of pipes includes a second pipe configured to be mechanically engaged with the first pipe, and the second pipe is configured to guide, in the first direction, air introduced into the second pipe in a third direction that is substantially opposite to the second direction.

The plurality of pipes includes a third pipe configured to be mechanically engaged with the second pipe, and the third pipe is configured to guide, in the third direction, air introduced into the third pipe in a direction that is substantially parallel to the first direction.

The heater module includes a first heater flange configured to be coupled to an end portion of the sleeve, and the first pipe is configured to be coupled to the first heater flange.

The heater module includes a second heater flange configured to be coupled to the other end portion of the sleeve that is opposite to the end portion, and the third pipe is configured to be coupled to the second heater flange.

The heater module includes a first heater cover configured to at least partially surround an outside of the sleeve.

The first heater cover includes an insulator.

The heater module includes a second heater cover configured to at least partially surround the outside of the sleeve and to be coupled to the first heater cover.

The first heater cover or the second heater cover is configured to be coupled to the first heater flange or the second heater flange.

The second pipe is configured to be coupled to the first heater cover.

The second pipe is configured to be mechanically engaged with the first heater cover.

The aerosol-generating device includes a housing accommodating the heater module and the plurality of pipes, wherein the housing includes an internal space in which air introduced from the outside flows.

The aerosol-generating device includes a slot disposed in the housing and a cap configured to slide relative to the slot, wherein the slot is connected to the internal space.

The aerosol-generating device includes a puff sensor configured to sense a puff of a user and disposed around the plurality of pipes.

According to an embodiment, an aerosol-generating device may guide an airflow into an aerosol generating article. According to an embodiment, air may flow along an airflow path. The effects of an aerosol-generating device are not limited to the above-mentioned effects, and other unmentioned effects can be clearly understood from the above description by those having ordinary skill in the technical field to which the present disclosure pertains.

### BRIEF DESCRIPTION OF THE DRAWINGS

The foregoing and other aspects, features, and advantages of embodiments in the disclosure will be apparent from the following detailed description with reference to the accompanying drawings.

FIG. 1 is a block diagram of an aerosol-generating device according to an embodiment.

FIG. 2A shows an aerosol-generating device according to an embodiment.

FIG. 2B shows an aerosol-generating device according to an embodiment.

FIG. 3 is a perspective view of an aerosol-generating device according to an embodiment.

FIG. 4 is a cross-sectional view of the aerosol-generating device taken along line 4-4 of FIG. 3.

FIG. 5 is a perspective view of a heater and a pipe according to an embodiment.

FIG. 6 is an exploded perspective view of a heater and a pipe according to an embodiment.

FIG. 7 is an exploded perspective view of a heater and a first pipe according to an embodiment.

FIG. 8 is a view of a fluid flow according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

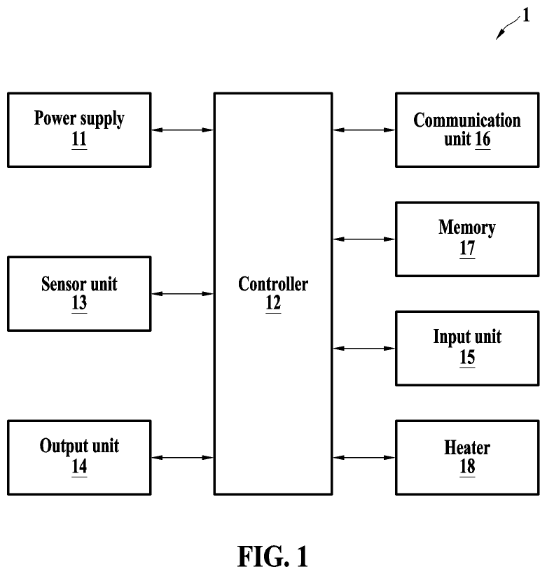

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

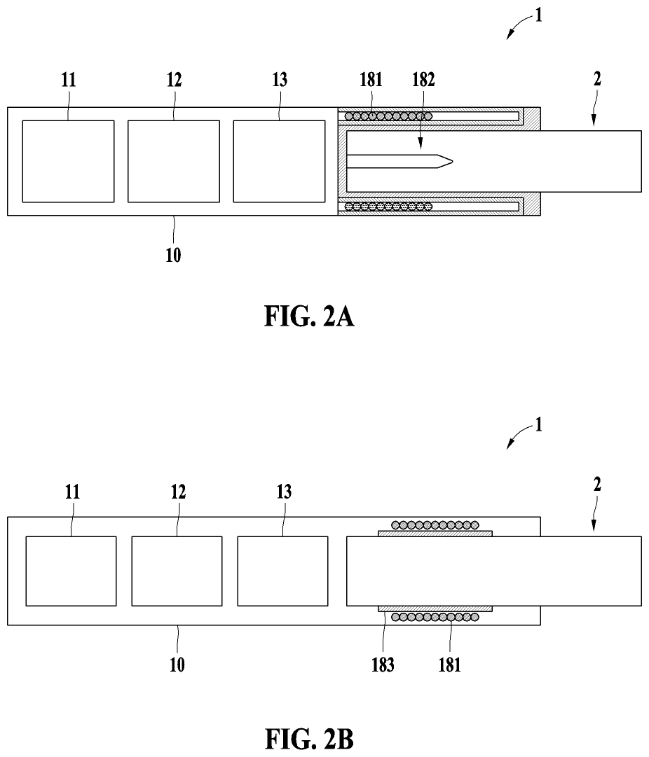

FIG. 2A shows an aerosol-generating device 1 according to an embodiment. FIG. 2B shows an aerosol-generating device 1 according to an embodiment.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2A or FIG. 2B and that some of the components may be omitted or new components may be further included. The aerosol-generating device 1 shown in FIG. 2A may be referred to as an “internal heating-type” aerosol-generating device that heats the inner side of an aerosol-generating article 2. The aerosol-generating device 1 shown in FIG. 2B may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2A, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 2B, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2A will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2A or FIG. 2B, both the heater 182 in FIG. 2A and the heater 183 in FIG. 2B may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

As used herein, the terms “substantially”, “approximately”, “generally”, and “about” in reference to a given parameter, property, or condition may include a degree that one of ordinary skill in the art would understand that the given parameter, property, or condition is met with a small degree of variance, such as within acceptable manufacturing tolerances. For example, a parameter that is substantially met may be at least 90% met, at least 95% met, or at least 99% met.

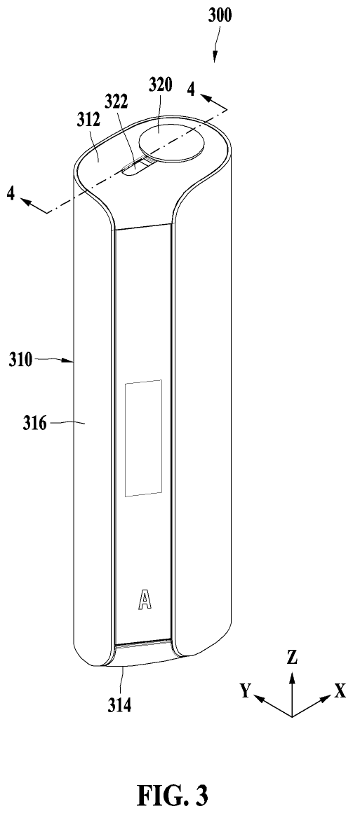

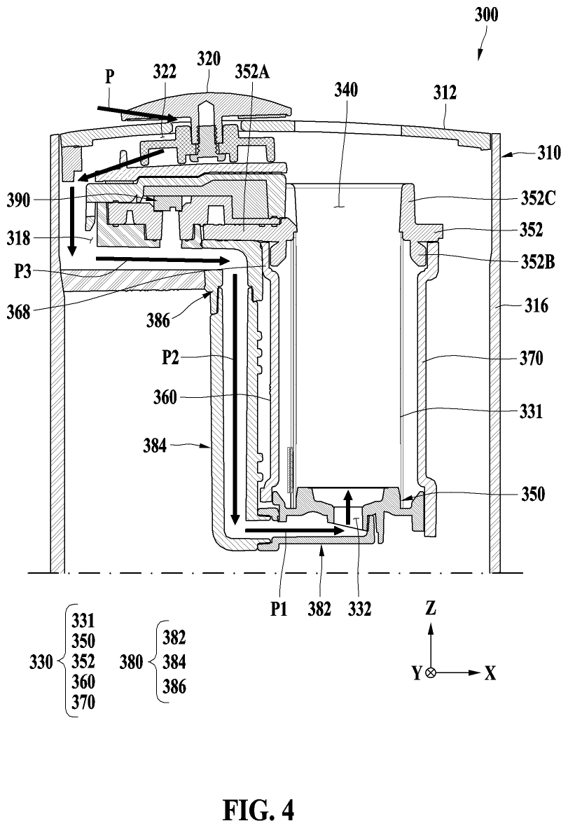

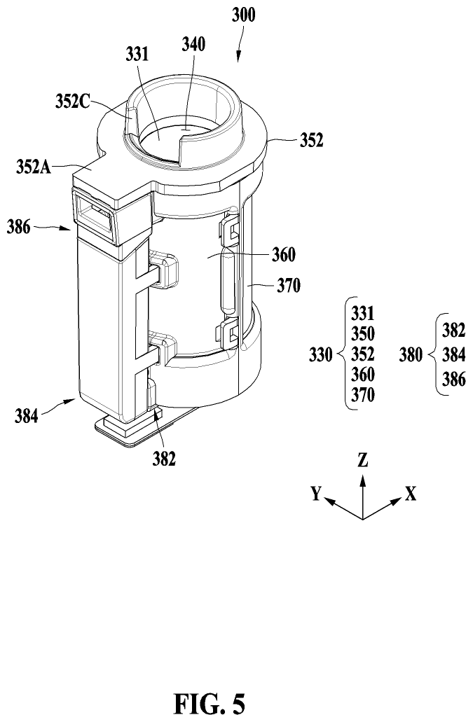

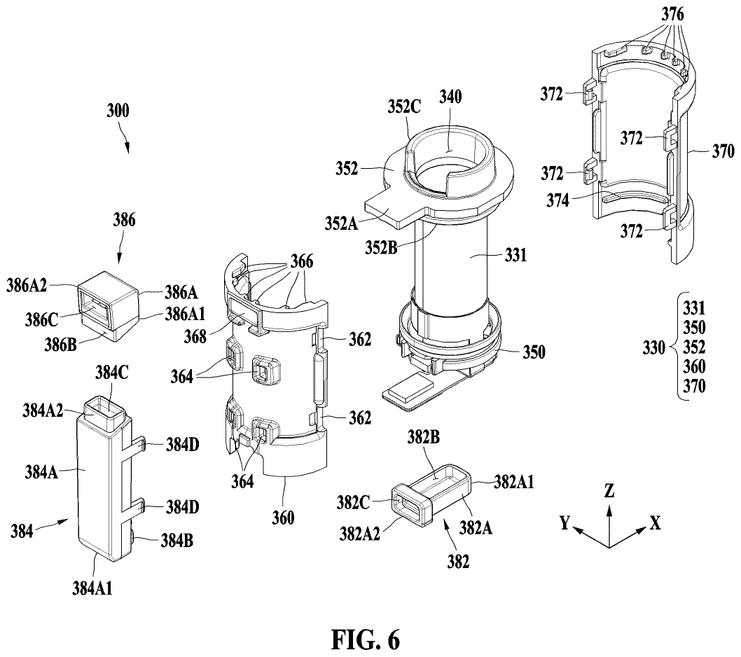

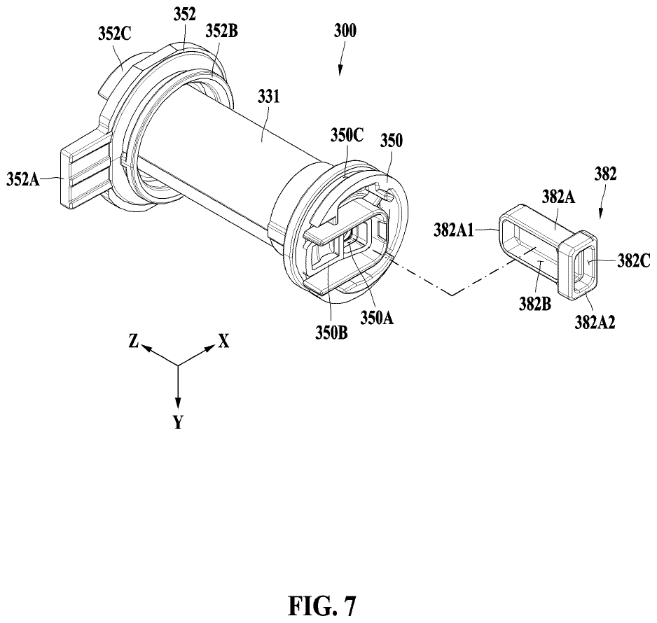

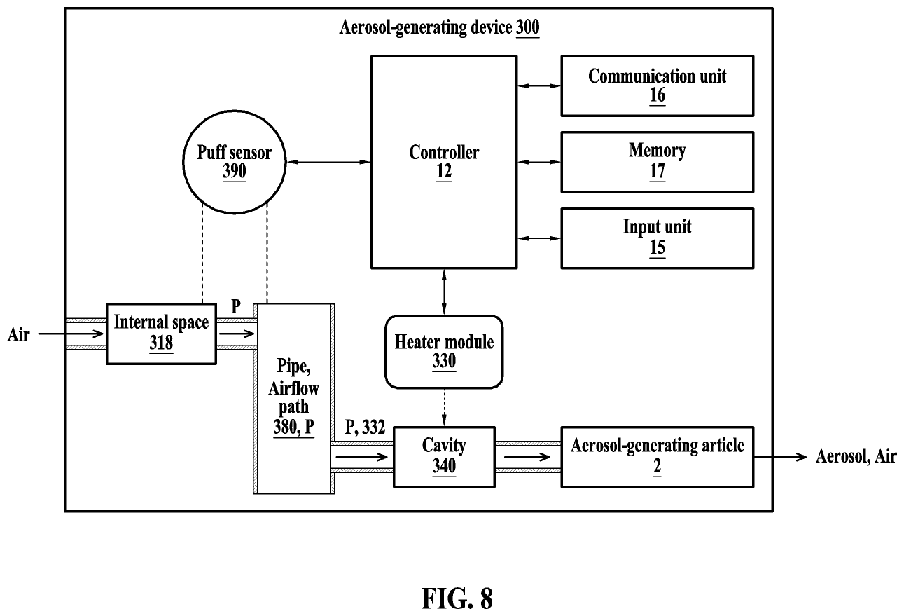

FIG. 3 is a perspective view of an aerosol-generating device according to an embodiment. FIG. 4 is a cross-sectional view of the aerosol-generating device taken along line 4-4 of FIG. 3. FIG. 5 is a perspective view of a heater and a pipe according to an embodiment. FIG. 6 is an exploded perspective view of a heater and a pipe according to an embodiment. FIG. 7 is an exploded perspective view of a heater and a first pipe according to an embodiment. FIG. 8 is a view of a fluid flow according to an embodiment.

Referring to FIGS. 3 to 8, an aerosol-generating device 300 may be configured to introduce air from the outside. The air from the outside may be delivered to the aerosol-generating article 2 along an airflow path P. The air may flow from the outside along the airflow path P leading to a cavity 340 (or the aerosol-generating article 2) through an internal space 318 of a housing 310 and a plurality of pipes 380. The aerosol-generating device 300 may efficiently deliver the air introduced from the outside to the aerosol-generating article 2. A user of the aerosol-generating device 300 may efficiently inhale an aerosol.

The aerosol-generating device 300 may include the housing 310. The housing 310 may be configured to accommodate at least one component (e.g., a heater module 330) related to the aerosol-generating device 300. The housing 310 may include a first housing surface 312, a second housing surface 314 that is opposite to the first housing surface 312, and a housing side surface 316 between the first housing surface 312 and the second housing surface 314. The housing side surface 316 may be formed as a single surface or a plurality of surfaces.

The housing 310 may include the internal space 318 in which at least one component is disposed. The internal space 318 may be defined by a wall (e.g., the first housing surface 312, the second housing surface 314, and the housing side surface 316) that defines the housing 310. In the internal space 318, at least a portion of the space in which a component is not disposed may be a part of the airflow path P. The components may be disposed in various positions in the housing 310 to form the airflow path P to guide air to the aerosol-generating article 2 in the internal space 318. The path of the airflow path P formed in the internal space 318 may vary depending on the shape or arrangement of the heater module 330 or the plurality of pipes 380.

The aerosol-generating device 300 may include a cap 320 and a slot 322 that are disposed in the housing 310. The cap 320 may slide relative to the slot 322. The cap 320 may slide relative to the slot 322 to open or close the cavity 340. The air outside the aerosol-generating device 300 may be introduced into the internal space 318 via the slot 322. In an embodiment not shown, the air introduced into the internal space 318 may be introduced via other portions of the housing 310 instead of the slot 322. For example, a gap connected to the internal space 318 may be provided in the housing 310 (e.g., the housing side surface 316), and the air may be introduced into the internal space 318 from the outside via the gap.

The aerosol-generating device 300 may further include the heater module 330 configured to heat the aerosol-generating article 2. A heating method by the heater module 330 is not limited. For example, the heater module 330 may be an induction heating type. The heater module 330 may include a sleeve 331 configured to accommodate an aerosol-generating article. The sleeve 331 may be configured to heat the aerosol-generating article 2. The heater module 330 may include the cavity 340 disposed inside the sleeve 331 and configured to accommodate the aerosol-generating article 2. The cavity 340 may be defined as an internal space of the sleeve 331. The heat generated in the sleeve 331 may be transferred to the cavity 340 and the aerosol-generating article 2.

The sleeve 331 may include an airflow channel 332 configured to guide the air (e.g., air in the plurality of pipes 380) from the outside to the cavity 340. The airflow channel 332 may be disposed at one end portion (e.g., an end portion in the −Z direction) of the sleeve 331. The airflow channel 332 may penetrate one surface (e.g., a surface in the −Z direction) of the sleeve 331. A portion of the airflow path P may be formed in the airflow channel 332. The airflow channel 332 may be formed to guide air to an end portion (e.g., an end portion in the −Z direction) of the aerosol-generating article 2 inserted into the cavity 340. In an embodiment not shown, the airflow channel 332 may formed to guide air to another portion (e.g., an intermediate portion) that is different from the end portion of the aerosol-generating article 2.

The heater module 330 may include a first heater flange 350 coupled to the end portion (e.g., the end portion in the −Z direction) of the sleeve 331. The first heater flange 350 may be coupled to at least one (e.g., a first pipe 382) of the plurality of pipes 380. The first heater flange 350 and at least one of the plurality of pipes 380 may be mechanically coupled to each other. For example, the first heater flange 350 and the first pipe 382 may be mechanically engaged with each other by fitting, screwing, or hooking. The first heater flange 350 and at least one of the plurality of pipes 380 may be magnetically coupled to each other. The first heater flange 350 and at least one of the plurality of pipes 380 may also be coupled to each other using a chemical substance. For example, the first heater flange 350 and the first pipe 382 may be bonded using an adhesive including a component that is not hazardous, even if inhaled by humans. The first heater flange 350 and at least one of the plurality of pipes 380 may be coupled to each other using two or more coupling methods described above. Although the present disclosure describes that the plurality of pipes 380 is coupled to the first heater flange 350 instead of the sleeve 331, the sleeve 331 or at least one of the plurality of pipes 380 may be directly coupled to each other.

The first heater flange 350 may include a flange hole 350A disposed at a position corresponding to the airflow channel 332. The first heater flange 350 may include a flange hole edge 350B disposed near the flange hole 350A and configured to be coupled to a portion (e.g., an end portion of the first pipe 382) of the plurality of pipes 380.

The first heater flange 350 may be coupled to another component (e.g., a first heater cover 360 and/or a second heater cover 370) of the heater module 330. The first heater flange 350 may include a groove 350C disposed along the outer surface of the first heater flange 350. The groove 350C may be mechanically engaged with at least one component of the heater module 330.

The heater module 330 may include a second heater flange 352 coupled to the other end portion (e.g., an end portion in the +Z direction) of the sleeve 331. The plurality of pipes 380 may be simultaneously coupled to the first heater flange 350 and the second heater flange 352 to be secured in the position. For example, one (e.g., the first pipe 382) of the plurality of pipes 380 may be coupled to the first heater flange 350, and the other one (e.g., a third pipe 386) may be coupled to the second heater flange 352. At least one (e.g., the third pipe 386) of the plurality of pipes 380 may be coupled to the second heater flange 352 mechanically, magnetically, or using a chemical substance. For example, at least one of the plurality of pipes 380 may be mechanically engaged with the second heater flange 352. For example, the plurality of pipes 380 may be engaged between the first heater flange 350 and the second heater flange 352.

The second heater flange 352 may be coupled to another component (e.g., the first heater cover 360 and/or the second heater cover 370) of the heater module 330 and/or at least one (e.g., the third pipe 386) of the plurality of pipes 380. The second heater flange 352 may include a flange extension 352A configured to extend from one side of the second heater flange 352 in a direction opposite to a first direction (e.g., the −X direction) and configured to be coupled to at least one (e.g., the third pipe 386) of the plurality of pipes. For example, one surface (e.g., the surface in the −Z direction) of the flange extension 352A may include a coupling portion configured to be coupled to one surface (e.g., the surface in the +Z direction) of the third pipe 386, and the second heater flange 352 may be coupled to the third pipe 386.

The second heater flange 352 may include a flange protrusion 352B that protrudes from the outer surface of the second heater flange 352. The flange protrusion 352B may be configured to be mechanically engaged with other components (e.g., first heater cover protrusions 366 or second heater cover protrusions 376) of the heater module 330.

The second heater flange 352 may include a flange expanding portion 352C that expands the outer surface of the second heater flange 352 in a third direction (e.g., the +Z direction). The flange expanding portion 352C may be configured to accommodate the aerosol-generating article 2 together with the sleeve 331. The flange expanding portion 352C may be configured to guide the aerosol-generating article 2 to be inserted into the cavity 340.

The heater module 330 may include the first heater cover 360 configured to at least partially surround the sleeve 331. The first heater cover 360 may be configured to surround a portion (e.g., a portion in the −X direction) of the outer surface of the sleeve 331. The first heater cover 360 may be configured to at least partially surround the sleeve 331 between the plurality of pipes 380 and the sleeve 331. For example, the first heater cover 360 may surround a portion of the outer surface of the sleeve 331 that faces the plurality of pipes 380. For example, the size of the portion that the first heater cover 360 surrounds the sleeve 331 may be substantially half of the size of the outer surface of the sleeve 331. The first heater cover 360 may include an insulator. The first heater cover 360 may include at least one first heater cover coupling portion 362 that secures the first heater cover 360 to the second heater cover 370. At least one first heater cover coupling portion 362 may be disposed at an end portion (e.g., the end portion in the +X direction) of the first heater cover 360. A plurality of first heater cover coupling portions 362 may be disposed at both end portions of the first heater cover 360 such that the plurality of first heater cover coupling portions 362 is spaced apart from each other in a direction (e.g., the + or −Y direction) that is substantially parallel or intersecting with the direction (e.g., the −Z direction) in which the aerosol-generating article 2 is inserted. For example, the first heater cover coupling portion 362 may be mechanically engaged with a second heater cover coupling portion 372. For example, the first heater cover coupling portion 362 may include a hook configured to be engaged with the second heater cover coupling portion 372 in the form of a hole.

The first heater cover 360 may include at least one pipe coupling portion 364 configured to be coupled to at least one (e.g., the second pipe 384) of the plurality of pipes 380. At least one pipe coupling portion 364 may be disposed on the outer surface (e.g., the surface in the −X direction or facing the plurality of pipes 380) of the first heater cover 360. At least one pipe coupling portion 364 may be formed as a hole that penetrates the first heater cover 360. At least one pipe coupling portion 364 may be coupled to at least one (e.g., the second pipe 384) of the plurality of pipes 380 mechanically, magnetically, or using a chemical substance. For example, the plurality of pipe coupling portions 364 may be mechanically engaged with the second pipe 384.

The plurality of pipe coupling portions 364 may be spaced apart from each other. For example, when there are four pipe coupling portions 364, two pipe coupling portions 364 may be spaced apart in a direction (e.g., the + or −Y direction) intersecting with the direction (e.g., the −Z direction) in which the aerosol-generating article 2 is inserted, and the other two pipe coupling portions 364 may be spaced apart in a direction (e.g., the +Z direction) opposite to the direction in which the aerosol-generating article 2 is inserted.

The first heater cover 360 may be coupled to other components (e.g., the first heater flange 350, the second heater flange 352, or the second heater cover 370) of the heater module 330. The first heater cover 360 may include at least one first heater cover protrusion 366 configured to be mechanically engaged with the flange protrusion 352B and disposed on the inner surface of an end portion (e.g., the end portion in the +Z direction) of the first heater cover 360.

The first heater cover 360 may include a third pipe coupling portion 368 configured to be coupled to at least one (e.g., the third pipe 386) of the plurality of pipes 380. For example, the third pipe coupling portion 368 may be disposed on the outer surface (e.g., the surface in the −X direction) of an end portion (e.g., the end portion in the +Z direction) of the first heater cover 360 and may be mechanically engaged with one surface (e.g., the surface in the +X direction) of the third pipe coupling portion 368.

The heater module 330 may include the second heater cover 370 configured to at least partially surround the sleeve 331 and configured to be coupled to the first heater cover 360. The second heater cover 370 may surround a portion (e.g., the portion in the +X direction), in which the first heater cover 360 does not surround the sleeve 331, of the outer surface of the sleeve 331. The portion in which the first heater cover 360 surrounds the sleeve 331 may be partially overlapped with the portion in which the second heater cover 370 surrounds the sleeve 331. The second heater cover 370 may include an insulator. The second heater cover 370 may include at least one second heater cover coupling portion 372 configured to be coupled to the first heater cover 360. The number of second heater cover coupling portions 372 may correspond to the number of first heater cover coupling portions 362. The second heater cover coupling portions 372 may be disposed to correspond to the first heater cover coupling portions 362, respectively. The first heater cover coupling portion 362 and the second heater cover coupling portion 372 may be coupled to each other mechanically, magnetically, or using a chemical substance. For example, the second heater cover coupling portion 372 may be mechanically engaged with the first heater cover coupling portion 362. For example, the second heater cover coupling portion 372 may include a hole that engages with the first heater cover coupling portion 362 in the form of a hook.

The second heater cover 370 may be coupled to other components (e.g., the first heater flange 350, the second heater flange 352, or the first heater cover 360) of the heater module 330. The second heater cover 370 may include a first flange coupling portion 374 configured to be mechanically engaged with the first heater flange 350 and disposed on the inner surface of an end portion (e.g., the end portion in the −Z direction) of the second heater cover 370. The first flange coupling portion 374 may be mechanically engaged with the groove 350C. For example, the first flange coupling portion 374 may protrude from the second heater cover 370, and the portion protruding from the second heater cover 370 may be fitted into the groove 350C. The second heater cover 370 may include at least one second heater cover protrusion 376 configured to be mechanically engaged with the flange protrusion 352B and disposed on the inner surface of an end portion (e.g., the end portion in the +Z direction) of the second heater cover 370.

The aerosol-generating device 300 may include the plurality of pipes 380 forming a portion of the airflow path P through which air introduced from the outside flows to the cavity 340. The plurality of pipes 380 may guide the air introduced from the outside to the cavity 340. The air introduced into the inside of the plurality of pipes 380 from the internal space 318 through the airflow path P may be guided to the cavity 340 via the airflow channel 332. The plurality of pipes 380 may guide substantially all or most of the air introduced into the internal space 318 from the outside to the cavity 340 via the plurality of pipes 380. The aerosol-generating device 300 may efficiently generate an aerosol by substantially preventing air from flowing through a path other than the airflow path P.

The plurality of pipes 380 may change a direction in which air flows. The air introduced into the plurality of pipes 380 in a direction may leak from the plurality of pipes 380 in a direction that is different from the direction in which the air is introduced. For example, the air introduced into one (e.g., the third pipe 386) of the plurality of pipes 380 in a first direction (e.g., the +X direction) may leak in a second direction (e.g., the +Z direction) intersecting with the first direction. The air introduced into one (e.g., the third pipe 386) of the plurality of pipes 380 in the first direction may be introduced into another pipe (e.g., the second pipe 384) in a third direction (e.g., the −Z direction) that is substantially opposite to the second direction. The air introduced into another pipe in the third direction may be introduced into another pipe (e.g., the first pipe 382) in the first direction.

The plurality of pipes 380 may include the first pipe 382 configured to form a portion (e.g., a first airflow path P1 of FIG. 4) of the airflow path P and configured to be coupled to the heater module 330. The first pipe 382 may be connected to the sleeve 331. The first pipe 382 may be coupled to the first heater flange 350. The first heater flange 350 may be mechanically coupled to the first pipe 382. For example, the first heater flange 350 and the first pipe 382 may be mechanically engaged with each other by fitting, screwing, or hooking. The first heater flange 350 may be magnetically coupled to the first pipe 382. The first heater flange 350 may be coupled to the first pipe 382 using a chemical substance. For example, the first heater flange 350 and the first pipe 382 may be bonded using an adhesive including a component that is not hazardous, even if inhaled by humans. The first heater flange 350 and the first pipe 382 may be coupled to each other using two or more coupling methods described above.

The first pipe 382 may include a first pipe extension 382A including a first end portion 382A1 (e.g., an end portion in the +X direction in FIG. 6) of the first pipe 382 and a second end portion 382A2 of the first pipe 382 that is opposite to the first end portion 382A1. The first pipe extension 382A may extend in the first direction (e.g., the +X direction). The first end portion 382A1 of the first pipe 382 may be coupled to the first heater flange 350, and the second end portion 382A2 of the first pipe 382 may be coupled to the the second pipe 384. The first pipe 382 may include a flange coupling hole 382B which is disposed close to the first end portion 382A1 than the second end portion 382A2, corresponds to the flange hole 350A, and through which air passes. The first pipe 382 may include a first hole 382C through which air (e.g., air introduced from the second pipe 384) introduced into the first pipe 382 passes. The first pipe 382 may guide the air passing through the first hole 382C to the cavity 340. The flange hole 350A and the flange coupling hole 382B may be arranged relative to an axis (e.g., the Z axis) in which the aerosol-generating article 2 is inserted to guide the air to the end portion (e.g., the end portion in the −Z direction) of the aerosol-generating article 2. In an embodiment not shown, the direction and position in which the first pipe 382 guides the air may vary depending on the design of the heater module 330.

The plurality of pipes 380 may include the second pipe 384 configured to form a portion (e.g., a second airflow path P2 of FIG. 4) of the airflow path P and configured to be coupled to the first pipe 382. The first pipe 382 may be mechanically coupled to the second pipe 384. For example, the first pipe 382 and the second pipe 384 may be mechanically engaged with each other by fitting, screwing, or hooking. The first pipe 382 may be mechanically coupled to the second pipe 384. The first pipe 382 may be coupled to the second pipe 384 using a chemical substance. For example, the first pipe 382 and the second pipe 384 may be bonded using an adhesive including a component that is not hazardous, even if inhaled by humans. The first pipe 382 and the second pipe 384 may be coupled to each other using two or more coupling methods described above.

The second pipe 384 may include a second pipe extension 384A including a first end portion 384A1 (e.g., an end portion in the −Z direction in FIG. 6) of the second pipe 384 and a second end portion 384A2 of the second pipe 384 that is opposite to the first end portion 384A1. The second pipe extension 384A may extend in the third direction (e.g., the −Z direction). The first end portion 384A1 of the second pipe 384 may be coupled to the first pipe 382, and the second end portion 384A2 of the second pipe 384 may be coupled to the the third pipe 386. The second pipe 384 may include a second hole 384B which is disposed close to the first end portion 382A1, corresponds to the first hole 382C, and through which air passes. The second pipe 384 may include a third hole 384C through which the introduced air (e.g., air introduced from the third pipe 386) passes. The second pipe 384 may guide the air passing through the third hole 384C to the first pipe 382. The second pipe 384 including the first hole 382C and the second hole 384B may guide the air introduced into the second pipe 384 in the third direction (e.g., the −Z direction) parallel to the direction in which the aerosol-generating article 2 is inserted. In an embodiment not shown, the air introduced into the second pipe 384 may be introduced in a different direction, or the air may be guided to the first pipe 382 in the first direction in a different direction.

The second pipe 384 may be coupled to the heater module 330. For example, the second pipe 384 may be coupled to the first heater cover 360. The second pipe 384 may include a cover coupling portion 384D configured to be coupled to the pipe coupling portion 364 of the first heater cover 360. At least one cover coupling portion 384D may be formed on one surface (e.g., the surface in the +X direction) of the second pipe extension 384A. At least one cover coupling portion 384D may be formed on a side surface (e.g., the surface in the + or −Y direction) of the second pipe extension 384A to face one surface (e.g., the surface in the +X direction). At least one cover coupling portion 384D may be disposed at a position corresponding to at least one pipe coupling portion 364. For example, when four pipe coupling portions 364 are formed as holes in the first heater cover 360, each of the four cover coupling portions 384D may include an engaging portion (e.g., a hook) disposed to correspond to each hole and engaged with each hole. At least one cover coupling portion 384D may be coupled to at least one pipe coupling portion 364 mechanically, magnetically, or using a chemical substance. For example, a plurality of cover coupling portions 384D may be mechanically engaged with the plurality of pipe coupling portions 364, respectively.

The plurality of pipes 380 may include the third pipe 386 configured to form a portion (e.g., a portion of a third airflow path P3 of FIG. 4) of the airflow path P and configured to be coupled to the second pipe 384. The second pipe 384 may be mechanically coupled to the third pipe 386. For example, the second pipe 384 and the third pipe 386 may be mechanically engaged with each other by fitting, screwing, or hooking. The second pipe 384 may be mechanically coupled to the third pipe 386. The second pipe 384 may be coupled to the third pipe 386 using a chemical substance. For example, the second pipe 384 and the third pipe 386 may be bonded using an adhesive including a component that is not hazardous, even if inhaled by humans. The second pipe 384 and the third pipe 386 may be coupled to each other using two or more coupling methods described above.

The third pipe 386 may include a third pipe extension 386A including a first end portion 386A1 (e.g., an end portion in the −Z direction in FIG. 6) of the third pipe 386 and a second end portion 386A2 of the third pipe 386 that is opposite to the first end portion 386A1. The third pipe extension 386A may extend in the first direction (e.g., the +X direction). The first end portion 386A1 of the third pipe 386 may be coupled to the second pipe 384, and the second end portion 386A2 of the third pipe 386 may be open to the internal space 318. The third pipe 386 may include a fourth hole 386B which is disposed at the first end portion 382A1, corresponds to the third hole 384C, and through which air passes. The third pipe 386 may include a fifth hole 386C through which air (e.g., air in the internal space 318 before entering the plurality of pipes 380 on the airflow paths P) introduced into the third pipe 386 passes. The third pipe 386 may guide the air introduced into the internal space 318 via the slot 322 or a gap in the housing 310 to the inside of the plurality of pipes 380 via the fifth hole 386C. The fifth hole 386C may be disposed on one surface (e.g., the surface in the −X direction in FIG. 6) of the third pipe extension 386A. This may allow the fifth hole 386C to guide the air in the first direction. In an embodiment not shown, the fifth hole 386C may be disposed on another surface of the third pipe extension 386A.

The present disclosure describes that the plurality of pipes 380 includes three pipes (e.g., the first pipe 382, the second pipe 384, and the third pipe 386). However, in an embodiment not shown, the plurality of pipes 380 may be a single piece, may include two pipes, or may include four or more pipes. The cross-sectional shape of each of the plurality of pipes 380 may be appropriately selected. For example, in the drawings, the cross-sections of the first, second, and third pipes 382, 384, and 386 are illustrated as rectangles, but are not limited thereto. The cross-sections of the first, second, and third pipes 382, 386, and 386 may be circular shapes or non-rectangular polygons.

The aerosol-generating device 300 may include a puff sensor 390 configured to output a signal corresponding to internal pressure of the aerosol-generating device 300. A control unit 12 may detect a puff of a user based on the signal corresponding to the internal pressure. The internal pressure of the aerosol-generating device 300 may correspond to pressure of a portion (e.g., the first airflow path P1, the second airflow path P2, the third airflow path P3, or other portions) of the airflow path P. The air introduced from the outside may be guided by the plurality of pipes 380, and the puff sensor 390 may measure a pressure change in the internal space 318 with relatively high accuracy. The puff sensor 390 may be disposed to correspond to the airflow path P. The puff sensor 390 may be disposed around the plurality of pipes 380. For example, the puff sensor 390 may be disposed around the fifth hole 386C of the third pipe 386 and may be configured to sense the pressure of the internal space 318. In an embodiment not shown, the puff sensor 390 may be disposed to correspond to the first airflow path P1, the second airflow path P2, or the third airflow path P3 to measure the internal pressure of the plurality of pipes 380. For example, the puff sensor 390 may be disposed to measure the internal pressure of the first pipe 382, the second pipe 384, or the third pipe 386.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. An aerosol-generating device comprising:
a heater module comprising a sleeve configured to accommodate an aerosol-generating article; and
a plurality of pipes configured to guide air from an outside to the sleeve,
wherein the plurality of pipes is configured to be mechanically engaged with each other, and
at least one of the plurality of pipes is configured to be mechanically engaged with the heater module.

2. The aerosol-generating device of claim 1, wherein the plurality of pipes comprises a first pipe connected to the sleeve, and
the first pipe is configured to guide, in a second direction, air introduced into the first pipe in a first direction in which the first pipe extends, wherein the second direction intersects with the first direction.

3. The aerosol-generating device of claim 2, wherein the plurality of pipes further comprises a second pipe configured to be mechanically engaged with the first pipe, and
the second pipe is configured to guide, in the first direction, air introduced into the second pipe in a third direction that is substantially opposite to the second direction.

4. The aerosol-generating device of claim 3, wherein the plurality of pipes further comprises a third pipe configured to be mechanically engaged with the second pipe, and
the third pipe is configured to guide, in the third direction, air introduced into the third pipe in a direction that is substantially parallel to the first direction.

5. The aerosol-generating device of claim 4, wherein the heater module further comprises a first heater flange configured to be coupled to an end portion of the sleeve, and
the first pipe is configured to be coupled to the first heater flange.

6. The aerosol-generating device of claim 5, wherein the heater module further comprises a second heater flange configured to be coupled to the other end portion of the sleeve that is opposite to the end portion, and
the third pipe is configured to be coupled to the second heater flange.

7. The aerosol-generating device of claim 6, wherein the heater module further comprises a first heater cover configured to at least partially surround an outside of the sleeve.

8. The aerosol-generating device of claim 7, wherein the first heater cover comprises an insulator.

9. The aerosol-generating device of claim 7, wherein the heater module further comprises a second heater cover configured to at least partially surround the outside of the sleeve and to be coupled to the first heater cover.

10. The aerosol-generating device of claim 9, wherein the first heater cover or the second heater cover is configured to be coupled to the first heater flange or the second heater flange.

11. The aerosol-generating device of claim 7, wherein the second pipe is configured to be coupled to the first heater cover.

12. The aerosol-generating device of claim 11, wherein the second pipe is configured to be mechanically engaged with the first heater cover.

13. The aerosol-generating device of claim 1, further comprising:
a housing accommodating the heater module and the plurality of pipes,
wherein the housing comprises an internal space in which air introduced from the outside flows.

14. The aerosol-generating device of claim 13, further comprising:
a slot disposed in the housing and a cap configured to slide relative to the slot, wherein the slot is connected to the internal space.

15. The aerosol-generating device of claim 1, further comprising:
a puff sensor configured to sense a puff of a user and disposed around the plurality of pipes.
